(19) United States
(12) Patent Application Publication
(10) Pub. No.: US 2010/0277506 A1
(43) Pub. Date: Nov. 4, 2010

(54) SYSTEM AND METHOD FOR ADJUSTING USER INTERFACE OF ELECTRONIC DEVICE

(75) Inventor: XU-QI YAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/683,569

(22) Filed: Jan. 7, 2010

(30) Foreign Application Priority Data
Apr. 30, 2009 (CN) 200910302039.8

(51) Int. Cl. G09G 5/00

(52) U.S. Cl. 345/650

(57) ABSTRACT

A system for adjusting user interfaces of electronic devices includes a sensor, a coordinate unit, a calculating unit, and a controlling unit. The sensor is operable to detect a rotation angle of the electronic device when the electronic device is rotated. After detecting the electronic device is rotated, the system further automatically adjusts the user interface of the electronic device by the coordinate unit, the calculating unit, and the controlling unit, so that at least two edges of the user interface are parallel to the horizon even if the electronic device is rotated.

### BACKGROUND

1. Technical Field

The present disclosure relates a system and a method for adjusting user interfaces of electronic devices.

2. Description of Related Art

Different electronic devices may have different user interfaces so as to satisfy user requirements. However, the typical user interface is designed with only a single display orientation and a single dimension. As shown in FIG. 1, the typical user interface is designed for vertical orientation of a “candy bar” style electronic device. When the “candy bar” style electronic device is rotated to be horizontal, it is difficult to read.

### BRIEF DESCRIPTION OF THE DRAWINGS

FIG. 1 is a block diagram of an embodiment of a system for automatically adjusting a user interface of an electronic device.

FIG. 2 shows an exemplary adjustment of the user interface when the electronic device is rotated.

FIG. 3 shows an exemplary user interface of the electronic device when the electronic device is rotated by an acute angle.

FIG. 4 is a flowchart illustrating a method for adjusting a user interface displayed on an electronic device.

### DETAILED DESCRIPTION

As used thereinafter, the word, “boundary of user interface” is defined as a display area of the user interface displayed on a screen of an electronic device.

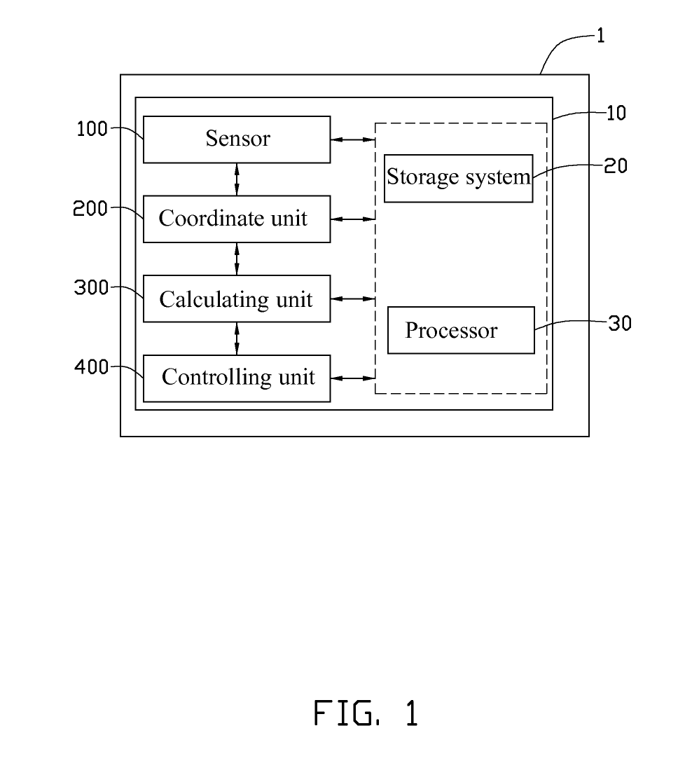

FIG. 1 is a block diagram of an embodiment of a system 10 for automatically adjusting a user interface of an electronic device 1. The system 10 includes a storage system 20, a processor 30, a sensor 100, a coordinate unit 200, a calculating unit 300, and a controlling unit 400.

The system 10 is generally controlled and coordinated by an operating system, such as UNIX, Linux, Windows, Mac OS, an embedded operating system, or any other compatible system. Alternatively, the system 10 may be controlled by a proprietary operating system. Typical operating systems control and schedule computer processes for execution, perform memory management, provide file system, networking, and I/O services, and provide a user interface, such as a graphical user interface (GUI), among other tasks.

The storage system 20 may comprise a database system comprising a searchable database of a plurality of items. In one example, the storage system may comprise a memory. The processor 30 may be used to execute one or more computerized operations for the units 100-400. The sensor 100 is operable to detect a rotation angle of the electronic device 1 when the electronic device 1 is rotated. The sensor 100 can be accelerometer or a g-sensor, for example.

The coordinate unit 200 is operable to establish a post-rotation coordinate axis and determining a post-rotation boundary of the user interface based on the rotation angle. The calculating unit 300 is operable to calculate location adjustments and dimension adjustments of objects shown on the user interface based on the post-rotation coordinate. The controlling unit 400 is operable to adjust the location and the dimension of the objects based on the location adjustments and the dimension adjustments. For example, the objects can be icons, text, and menus displayed on the user interface.

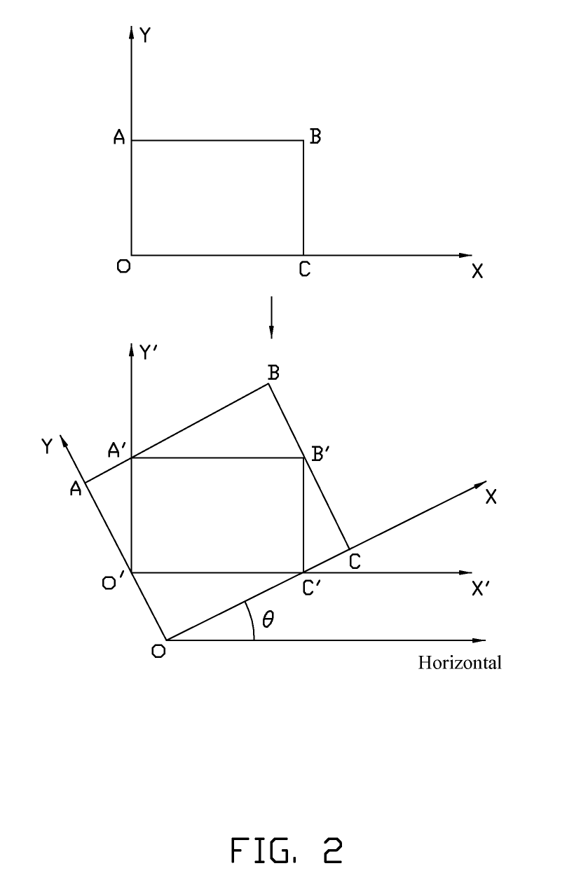

FIG. 2 shows an exemplary adjustment of the user interface when the electronic device 1 is rotated. A screen boundary O-A-B-C of the electronic device 1 is defined at a coordinate axis XOY. The screen boundary defines a visible area of the screen. An initial boundary of the user interface equals the screen boundary O-A-B-C when the electronic device 1 is horizontally oriented. When the electronic device 1 is rotated counterclockwise by an angle θ, the screen boundary O-A-B-C is accordingly rotated with the coordinate axis XOY. The angle θ is not an integral multiple of 0° or 90°. The coordinate unit 200 calculates a post-rotation coordinate axis X′O′Y′ rotating clockwise by angle θ corresponding to the post-rotation coordinate axis XOY.

When the electronic device 1 is rotated counterclockwise, an origin O′ of the post-rotation coordinate axis X′O′Y′ is defined on axis Y of the post-rotation coordinate axis XOY. When the electronic device 1 is rotated clockwise, the origin O′ of the post-rotation coordinate axis X′O′Y′ is defined on axis X of the post-rotation coordinate axis XOY. The coordinate unit 200 calculates a maximum rectangle O′-A′-B′-C′ adjacent to the post-rotation screen boundary O-A-B-C with a corner of the maximum rectangle O′-A′-B′-C′ on the origin O′. The coordinate unit 200 further arranges the maximum rectangle O′-A′-B′-C′ in a first quadrant of the post-rotation coordinate axis. The maximum rectangle O′-A′-B′-C′ is defined as the post-rotation user interface.

The calculating unit 300 calculates a ratio k of a post-rotation width to an ante-rotation width of the user interface and a ratio t of a post-rotation height to an ante-rotation height of the user interface. The calculating unit 300 determines location adjustments and dimension adjustments of the objects on the user-interface in accordance with the ratio k, the ratio t, and ante-rotation locations and ante-rotation dimensions of the objects.

The controlling unit 40 adjusts the locations and the dimensions of the objects on the user interface based on the location adjustments and dimension adjustments.

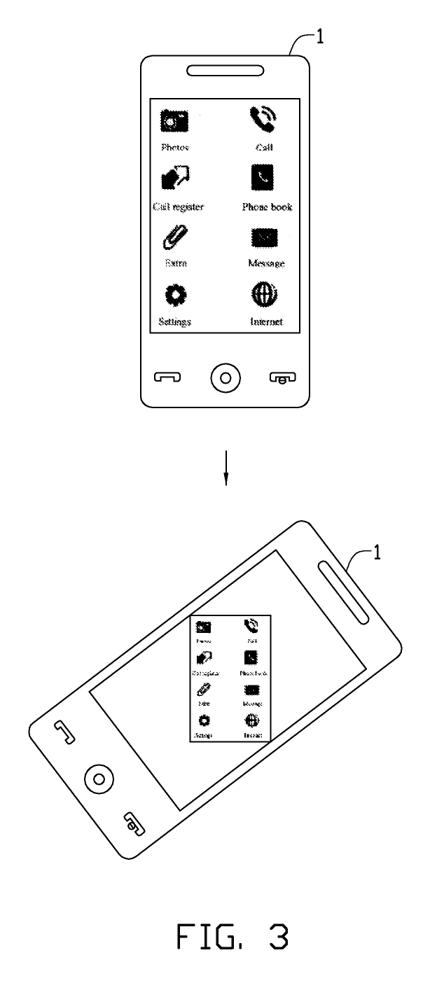

FIG. 3 shows an exemplary user interface of the electronic device when the electronic device is rotated by an acute angle. When the electronic device 1 is rotated clockwise by an acute angle, the user interface rotates counterclockwise by the acute angle. In addition, the boundary of the user interface is reduced to the maximum rectangle adjacent to the screen of the electronic device 1, and the maximum rectangle parallels the horizon.

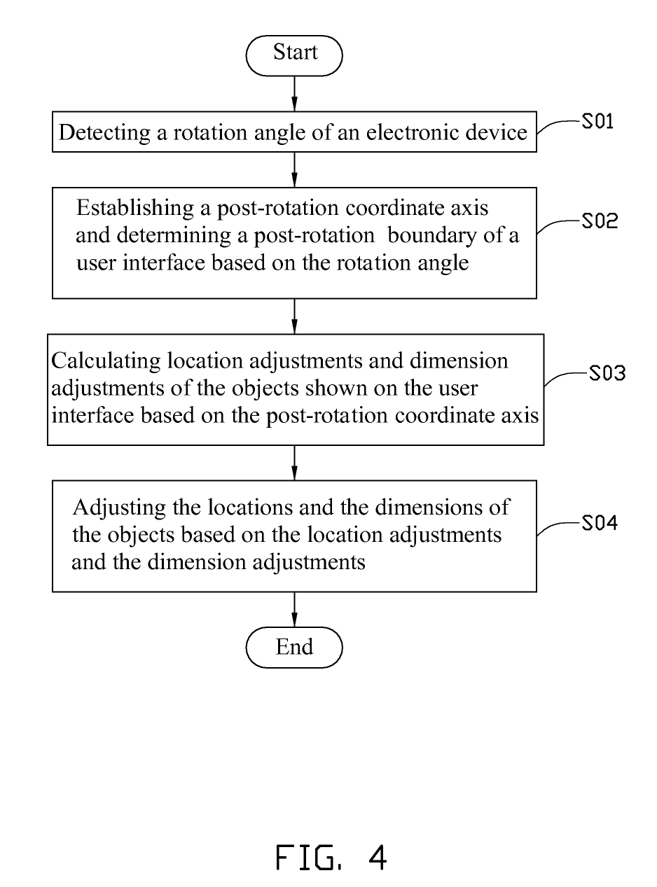

FIG. 4 is a flowchart illustrating a method for adjusting a user interface displayed on an electronic device. Depending on the embodiment, additional blocks in the flow of FIG. 4 may be added, others removed, and the ordering of the blocks may be changed.

In block S01, the sensor 100 detects a rotation angle of the electronic device 1 when the electronic device 1 is rotated. In block S02, the coordinate unit 200 then establishes the post-rotation coordinate axis and determines the post-rotation boundary of the user interface based on the rotation angle.

In block S03, the calculating unit 300 calculates the location adjustments and the dimension adjustments of the objects shown on the user interface based on the post-rotation coordinate axis.

In block S04, the controlling unit 400 adjusts the locations and dimensions of the objects on the user interface based on the location adjustments and the dimension adjustments of the objects.

The present disclosure automatically adjusts the user interface of the electronic device 1 so that at least two edges of the user interface are parallel to the horizon even if the electronic device is rotated. Such function provides convenience for users when operating the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for adjusting a user interface displayed on a screen of an electronic device, the method comprising:
defining an ante-rotation coordinate axis of the user interface when the electronic device is in a vertical status or in a horizontal status;
detecting a rotation angle of the electronic device;
establishing a post-rotation coordinate axis of the user interface based on the rotation angle;
determining a post-rotation boundary of the user interface based on the rotation angle;
calculating location adjustments and dimension adjustments of objects shown on the user interface based on the post-rotation coordinate axis; and
adjusting the locations and the dimensions of the objects on the user interface based on the location adjustments and dimension adjustments.

2. The method of claim 1, wherein establishing the post-rotation coordinate axis further comprises:
defining an origin of the post-rotation coordinate axis on an axis of the ante-rotation coordinate axis.

3. The method of claim 2, wherein the step of determining the post-rotation boundary of the user interface further comprises:
calculating a maximum rectangle with a corner located on the origin, adjacent to a boundary of the screen based on the post-rotation coordinate axis; and
defining the maximum rectangle as the post-rotation boundary of the user interface.

4. The method of claim 3, further comprising:
arranging the maximum rectangle in a first quadrant of the post-rotation coordinate axis.

5. The method of claim 4, further comprising:
adjusting the maximum rectangle to parallel a horizon.

6. The method of claim 1, wherein the step of calculating the location adjustments and dimension adjustments of the objects further comprises:
calculating a ratio k of the width of the post-rotation boundary of the user interface to the width of the boundary of the screen;
calculating a ratio t of the height of the post-rotation boundary of the user interface to the height of the boundary of the screen; and
determining the location adjustments and dimension adjustments of the objects in accordance with the ratio k, the ratio t, ante-rotation locations, and ante-rotation dimensions of the objects.

7. A system capable of automatically adjusting a user interface of an electronic device, the system comprising:
a sensor operable to detect a rotation angle of the electronic device;
a coordinate unit operable to establish a post-rotation coordinate axis and determine a post-rotation boundary of the user interface based on the rotation angle;
a calculating unit operable to calculate location adjustments and dimension adjustments of objects on the user interface based on the post-rotation coordinate; and
a controlling unit operable to adjust the locations and the dimensions of the objects on the user interface based on the calculated locations and dimensions of the objects.

8. The system of claim 7, wherein the coordinate unit is further operable to establish an ante-rotation coordinate axis.

9. The system of claim 7, wherein an origin of the post-rotation coordinate axis is located on an axis of the ante-rotation coordinate axis.

10. The system of claim 9, wherein the post-rotation boundary of the user interface is defined on a maximum rectangle adjacent to the boundary of the screen based on the post-rotation coordinate axis, and a corner of the maximum rectangle is located on the origin.

11. The system of claim 10, wherein the maximum rectangle is arranged in a first quadrant of the post-rotation coordinate axis.

12. The system of claim 11, wherein the maximum rectangle and the objects parallel a horizon.

13. The system of claim 12, wherein the objects are icons, texts, and/or menus of the user interface.

14. A storage medium having stored thereon instructions that, when executed by a processor, causing the processor to perform a method for adjusting a user interface displayed on a screen of an electronic device, wherein the method comprises:
define an ante-rotation coordinate axis of the user interface when the electronic device is in a vertical status or in a horizontal status;
detect a rotation angle of the electronic device;
establish a post-rotation coordinate axis of the user interface based on the rotation angle;
determine a post-rotation boundary of the user interface based on the rotation angle;
calculate location adjustments and dimension adjustments of objects shown on the user interface based on the post-rotation coordinate axis; and
adjust the locations and the dimensions of the objects on the user interface based on the location adjustments and dimension adjustments.

15. The storage medium of claim 14, wherein establish the post-rotation coordinate axis further comprises:
define an origin of the post-rotation coordinate axis on an axis of the ante-rotation coordinate axis.

16. The storage medium of claim 15, wherein determine the post-rotation boundary of the user interface further comprises:
calculate a maximum rectangle with a corner located on the origin, adjacent to a boundary of the screen based on the post-rotation coordinate axis; and
define the maximum rectangle as the post-rotation boundary of the user interface.

17. The storage medium of claim 16, wherein the method further comprises:
arrange the maximum rectangle in a first quadrant of the post-rotation coordinate axis.

18. The storage medium of claim 17, wherein the method further comprises:
adjust the maximum rectangle to parallel a horizon.

19. The storage medium of claim 14, wherein calculate the location adjustments and dimension adjustments of the objects further comprises:
calculate a ratio k of the width of the post-rotation boundary of the user interface to the width of the boundary of the screen;
calculate a ratio t of the height of the post-rotation boundary of the user interface to the height of the boundary of the screen; and
determine the location adjustments and dimension adjustments of the objects in accordance with the ratio k, the ratio t, ante-rotation locations, and ante-rotation dimensions of the objects.
